(19) United States
(12) Patent Application Publication
(10) Pub. No.: US 2011/0028150 A1
(43) Pub. Date: Feb. 3, 2011

(54) Method of Updating Management Information and Related Communication Device

(76) Inventor: Mamadou Kone, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/849,020

(22) Filed: Aug. 3, 2010

Related U.S. Application Data
(60) Provisional application No. 61/230,756, filed on Aug. 3, 2009.

(51) Int. Cl. H04W 36/00

(52) U.S. Cl. 455/436

(57) ABSTRACT

A method of updating management information for a mobile device in a wireless communication system is disclosed. The method comprises performing a procedure involved in a cell change from a first cell to a second cell; sending a first request to a network for first assistance data associated with the second cell when the procedure is finished; and receiving the first assistance data from the network.

### CROSS REFERENCE TO RELATED APPLICATIONS

This application claims the benefit of U.S. Provisional Application No. 61/230,756, filed on Aug. 3, 2009 and entitled “Methods for resolving possible obsolete management information when UE is in mobility during positioning service” the contents of which are incorporated herein.

### BACKGROUND OF THE INVENTION

1. Field of the Invention

A method used in a wireless communication system and related communication device are provided, and more particularly to, a method of updating management information in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

In the LTE system, a logical connection between the UE and the E-UTRAN is defined by radio resource control (RRC) connection states. The RRC connection states of the UE contain an RRC IDLE state and an RRC_CONNECTED state. In the RRC_CONNECTED state, the E-UTRAN controls mobility by ordering the UE to perform a handover procedure to another cell, which may be on the same frequency (intra-frequency) or a different frequency (inter-frequency). The E-UTRAN may also use the handover procedure for completely different purpose, such as to change the security keys to a new key set, or to perform a “synchronized” reconfiguration in which the E-UTRAN and the UE apply the new configuration simultaneously.

The purpose of a RRC connection reestablishment procedure is to re-establish the RRC connection, which involved resumption of signaling radio bearer SRB1 operation and re-activation of security. The SRB1 is for a RRC message which use a dedicated control channel (DCCH). The UE in the RRC_CONNECTED state, for which security has been activated, may initiate the RRC connection reestablishment procedure in order to continue the RRC connection. The connection re-establishment succeeds only if the concerned cell is prepared i.e. has a valid context of the UE. In case E-UTRAN accepts the re-establishment, the SRB1 operation resumes while the operation of other radio bearers remains suspended.

Positioning is a basic function that performs the actual positioning of a specific target UE. The input to the positioning function is a positioning request from a location service (LCS) client with a set of parameters such as QoS requirements. The end results of the positioning function are the location information for the positioned target UE. By measuring radio signals, the capability to determine the geographic position and velocity of the target UE shall be provided. The location information may be requested by and reported to the LCS client (application) associated with the target UE, or by a LCS client within or attached to a core network (CN). The position information may also be utilized internally by the E-UTRAN, for example, for location-assisted handover or to support other features such as home location billing. The position information shall be reported in standard formats, such as those for cell based or geographical co-ordinates, together with the estimated errors (uncertainty) of the position and velocity of the UE and, if available, the positioning method (or the list of the methods) is used to obtain the position estimate.

During the positioning of the UE, if ever UE receives a handover command from the eNB, the information exchanged with the server may be obsolete after the handover procedure. According to the method of positioning used, some management information may be specific to UE actual position and also contain additional information related to its cell (assistance data request). Therefore, if the UE move to another cell and even though the network locates UE to resume the positioning service, the server or UE may provide inaccurate management information for the remaining positioning procedure, because based on previous location of UE.

If the eNB is the LCS client for positioning service, and during the positioning of the UE it happens that UE has to handover to another cell, some management information exchanged with the server or the result location estimate might be obsolete after the handover procedure. Even though the eNB is responsible of the handover, but the UE procedure is terminated at UE and the server sides. Therefore, if UE does handover to another cell, a simple transfer to the target eNB of the ongoing positioning may produce inaccurate result. This is because some information exchanged after the handover or even the final location information sent to target eNB may be inaccurate because related to previous location of UE

During the positioning of the UE, if the UE detects a RLF (Radio Link Failure) and triggers an RRC connection re-establishment procedure this may interrupt the ongoing procedure (e.g. positioning) until RRC connection re-establishment is completed. The re-establishment might involve a cell change and in that case it is not predicted by the eNB, also the time to complete the RRC re-establishment to the new cell could be much longer than a normal handover. Therefore, after completing the RRC connection re-establishment when the UE and the server resume the positioning some management information exchanged between the UE and the server may be obsolete because based on previous inaccurate information (cell information, measurements etc).

If the eNB is the LCS client for the positioning service, and during the positioning the UE detects the RLF and triggers the RRC connection re-establishment to another cell, this may interrupt the ongoing UE procedure (e.g. positioning) until the re-establishment is completed. In this situation the re-establishment might involve a cell change and the eNB may know UE location only after the UE has camped on a new cell. Therefore, after completing RRC connection re-establishment a simple transfer to the target eNB of the ongoing location service may produce inaccurate result because some information exchanged or even the final location estimate may be obsolete.

### SUMMARY OF THE INVENTION

A method of updating management information in a wireless communication system and related communication device are provided to avoid the updating management information getting obsolete after a specific procedure.

A method of updating management information for a mobile device in a wireless communication system is disclosed. The method includes the steps of performing a procedure involved in a cell change from a first cell to a second cell; sending a first request to a network for first assistance data associated with the second cell when the procedure is finished; and receiving the first assistance data from the network.

A communication device of updating management information in a wireless communication system is disclosed. The communication device includes means for performing a procedure involved in a cell change from a first cell to a second cell; means for sending a first request to a network for first assistance data associated with the second cell when the procedure is finished; and means for receiving the first assistance data from the network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an exemplary wireless communication system.

FIG. 2 illustrates a schematic diagram of an exemplary communication device.

FIG. 3 is a flow chart of an exemplary process.

FIGs. 4-7 illustrate sequence diagrams between a UE and a server according to an exemplary of the present disclosure.

### DETAILED DESCRIPTION

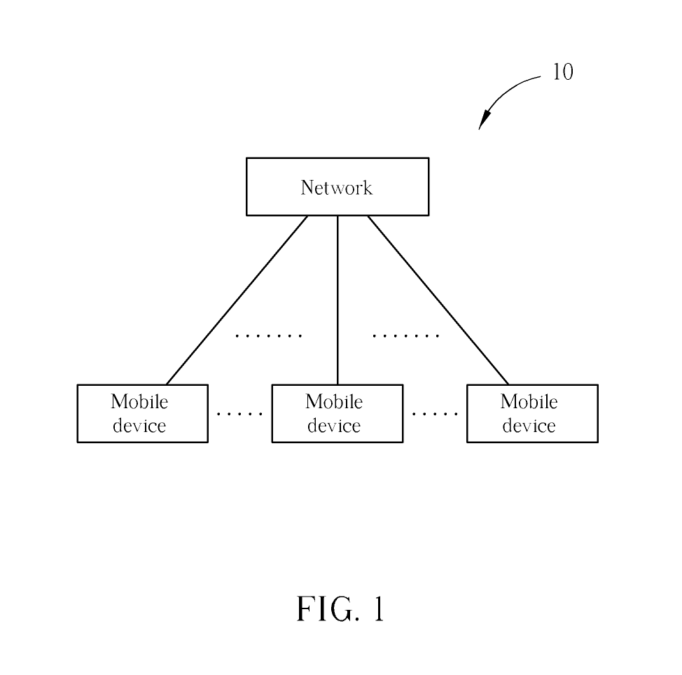

Please refer to FIG. 1, which illustrates a schematic diagram of an exemplary wireless communication system 10. Briefly, the wireless communication system 10 is composed of a network and a plurality of mobile devices. The wireless communication system 10 can be a UMTS (Universal Mobile Telecommunications System), an LTE (long-term evolution), LTE-Advance system or any other similar network system. In the LTE system, the network can be referred as a EUTRAN (evolved-UTRAN) comprising a plurality of eNBs or a core network entity (e.g. Mobility Management Entity (MME), Evolved Serving Mobile Location Center (E-SMLC) and Evolved Packet Core Location Service (EPC-LCS) entity), whereas the mobile devices are referred as to user equipments (UEs) that can be devices such as mobile phones, computer systems, etc. This terminology will be used throughout the application for ease of reference, however, this should not be construed as limiting the disclosure to any one particular type of network. In some examples, the network and the UE may be seen as a transmitter or receiver according to transmission direction, e.g., for uplink (UL), the UE is the transmitter and the network is the receiver, and for downlink (DL), the network is the transmitter and the UE is the receiver.

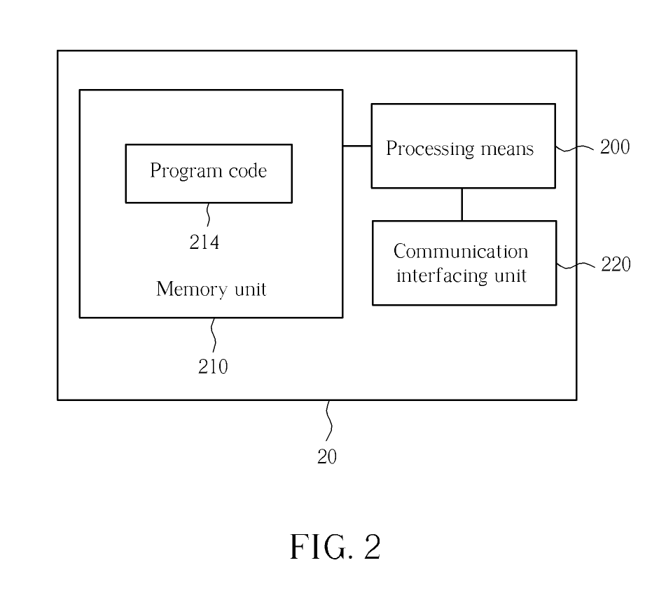

Please refer to FIG. 2, which illustrates a schematic diagram of an exemplary communication device 20. The communication device 20 may be the mobile devices or the network shown in FIG. 1 and may include a processor 200 such as a microprocessor or ASIC, a memory unit 210 and a communication interfacing unit 220. The memory unit 210 may be any data storage device that can store program code 214 for access by the processor 200. Examples of the memory unit 210 include but are not limited to a subscriber identity module (SIM), read-onlymemory (ROM), random-accessmemory (RAM), CD-ROMs, magnetic tapes, hard disks, and optical data storage devices. The communication interfacing unit 220 may be preferably a radio transceiver and accordingly exchanges wireless signals according to processing results of the processor 200.

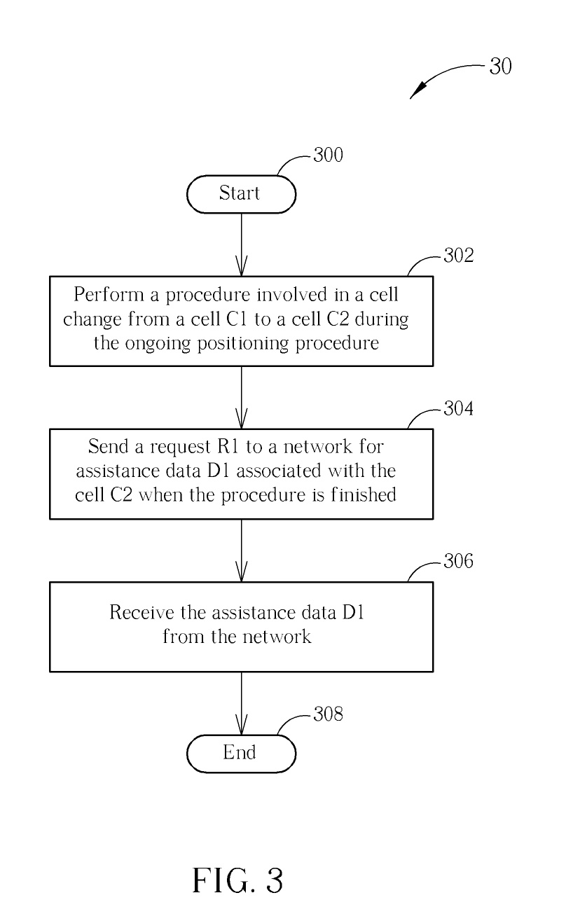

Please refer to FIG. 3, which is a flow chart of an exemplary process 30. The process 30 is used for updating management information associated with positioning for a UE in a wireless communication system. The UE has an ongoing positioning procedure. The process 30 may be compiled into the program code 214 and include the following steps:

Step 300: Start.

Step 302: Perform a procedure involved in a cell change from a cell C1 to a cell C2 during the ongoing positioning procedure.

Step 304: Send a request R1 to a network for assistance data D1 associated with the cell C2 when the procedure is finished.

Step 306: Receive the assistance data D1 from the network.

Step 308: End.

According to the process 30, the UE may move from the cell C1 to the cell C2 via the procedure during the ongoing positioning procedure. The procedure may be referred as to a handover procedure, a radio resource control (RRC) connection re-establishment procedure, or any procedure involved in the cell change. The RRC connection re-establishment procedure is triggered when the UE detects a radio link failure. The UE may send the request R1 to request the network for the assistance data D1 when the procedure is finished. The assistance data D1 is associated with the cell C2 and corresponds to updated location information of the UE and cell information associated with the cells C2 and some neighboring cells. The cell information includes cell identities of a serving base station controlling the cell C2 and neighbor base stations controlling the neighboring cells.

In other words, the UE is located within coverage of the cell C1 and performing the positioning procedure. The UE may send a request R2 to request the network for assistance data D2 associated with the cell C1 for the positioning. The assistance data D2 is associated with the cell C1 and corresponds to location information of the UE and cell information associated with the cells C1 and some neighboring cells. After the UE has requested and received the assistance data D2, the procedure (e.g. handover procedure or RRC re-establishment procedure) may be triggered. When the procedure is finished, the assistance data D2 could be obsolete since the UE may have moved from the cell C1 to the cell C2. Therefore, the UE sends a new request (e.g. request R1) to the network for the updated assistance data associated with the cell C2 (e.g. the assistance data D1). Namely, every time the procedure involved with the cell change occurs, the UE may resend a new request for updated management information (i.e. the assistance data). Consequently, after completing the procedure (e.g. handover procedure or RRC re-establishment procedure), the UE and the network resume the positioning and keep management information updated (cell information, measurements etc).

Besides, the UE may receive a request R3 from the network before the procedure is performed. The request R3 is used to request the UE to send location information LI1 corresponding to the cell C1 to the network, and however the UE does not send the location information LI1 because the receipt of the request R3. After the procedure, the UE may send a new request (e.g. request R1) to the network for the updated assistance data (e.g. the assistance data D1) until the UE sends new location information LI2 to the network. The location information LI2 corresponds to the cell 2. Beside, the UE may provide a location estimation result for the network. The location estimation result is calculated based on the location information LI2 corresponding to the cell C2.

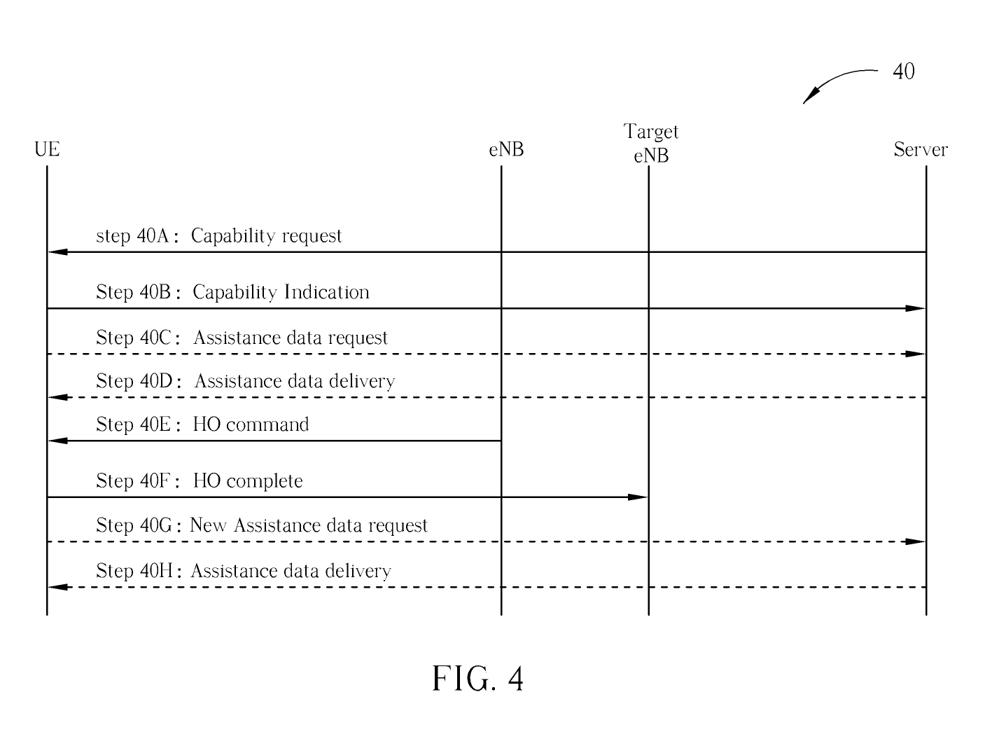

Please refer to FIG. 4, which illustrates a sequence diagram 40 between a UE and a server according to an exemplary of the present disclosure. In the Steps 40A and 40B, the server sends a capability request to the UE, and the UE sends the capability indication back to the server. In the Steps 40C and 40D, the UE sends an assistance data request to the server, and the server delivers the assistance data to the UE. In the step 40E, an eNB sends a handover command to the UE for initiation of a handover procedure. In the step 40F, the UE notifies a target eNB that handover procedure is completed. After the handover procedure, the UE moves from a serving cell (e.g. cell C1) to a new cell (e.g. Cell C2). The assistance data the UE has received is merely associated with the serving cell (e.g. cell C1) and turns obsolete for the positioning. Since the handover procedure may be involved in the cell change, the UE sends a new assistance data request to the server after the completion of the handover procedure (Step 40G). In the step 40H, the server sends the UE the updated assistance data.

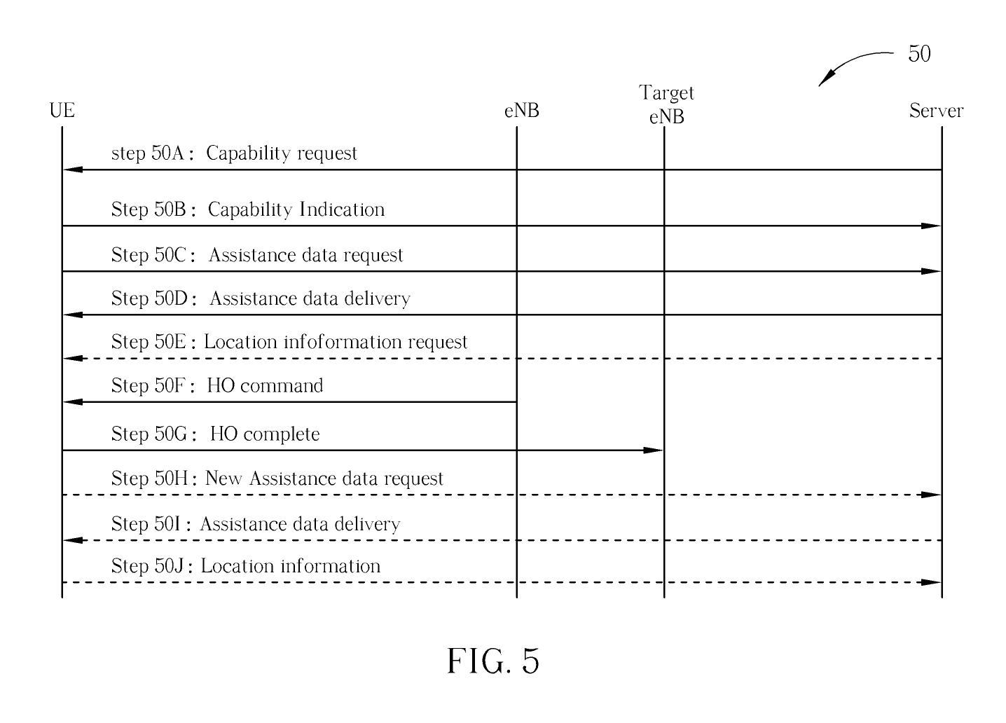

Please refer to FIG. 5, which illustrates a sequence diagram 50 between a UE and a server according to an exemplary of the present disclosure. In the Steps 50A and 50B, the server sends a capability request to the UE, and the UE sends the capability indication back to the server. In the Steps 50C and 50D, the UE sends an assistance data request to the server, and the server delivers the assistance data to the UE. The server sends a location information request to the UE in the Step 50E. In the steps 50F and 50G an eNB sends a handover command to the UE for initiation of a handover procedure, and the UE notifies a target eNB that handover procedure is completed. After the handover procedure, the UE moves from a serving cell (e.g. cell C1) to a new cell (e.g. Cell C2). The assistance data the UE has received is merely associated with the serving cell (e.g. cell C1) and turns obsolete for the positioning. Therefore, the UE sends a new assistance data request to the server (step 50H). In the step 50I, the server sends the UE the updated assistance data. In the step 50J the UE sends location information to the server.

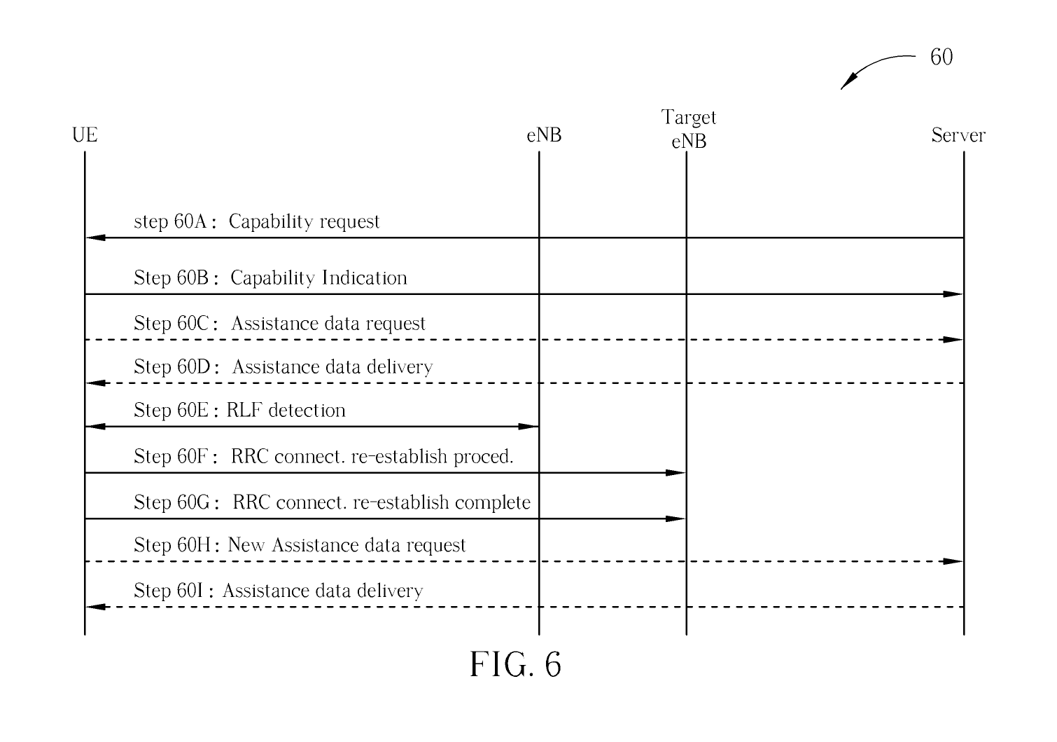

Please refer to FIG. 6, which illustrates a sequence diagram 60 between a UE and a server according to an exemplary of the present disclosure. In the Steps 60A and 60B, the server sends a capability request to the UE, and the UE sends the capability indication back to the server. In the Steps 60C and 60D, the UE sends an assistance data request to the server, and the server delivers the assistance data to the UE. In the steps 60E and 60F, the UE detects a radio link failure and thus performs an RRC connection re-establishment procedure to an eNB. The RRC connection re-establishment procedure is involved in the cell change. In the step 60G, the UE notifies a target eNB that the RRC connection re-establishment procedure is completed. After the RRC connection re-establishment procedure, the UE moves from a serving cell (e.g. cell C1) to a new cell (e.g. Cell C2). The assistance data the UE has received is merely associated with the serving cell (e.g. cell C1) and turns obsolete for the positioning. Thus, the UE sends a new assistance data request to the server (Step 60H) after the RRC connection re-establishment procedure. In the step 601, the server sends the UE the updated assistance data.

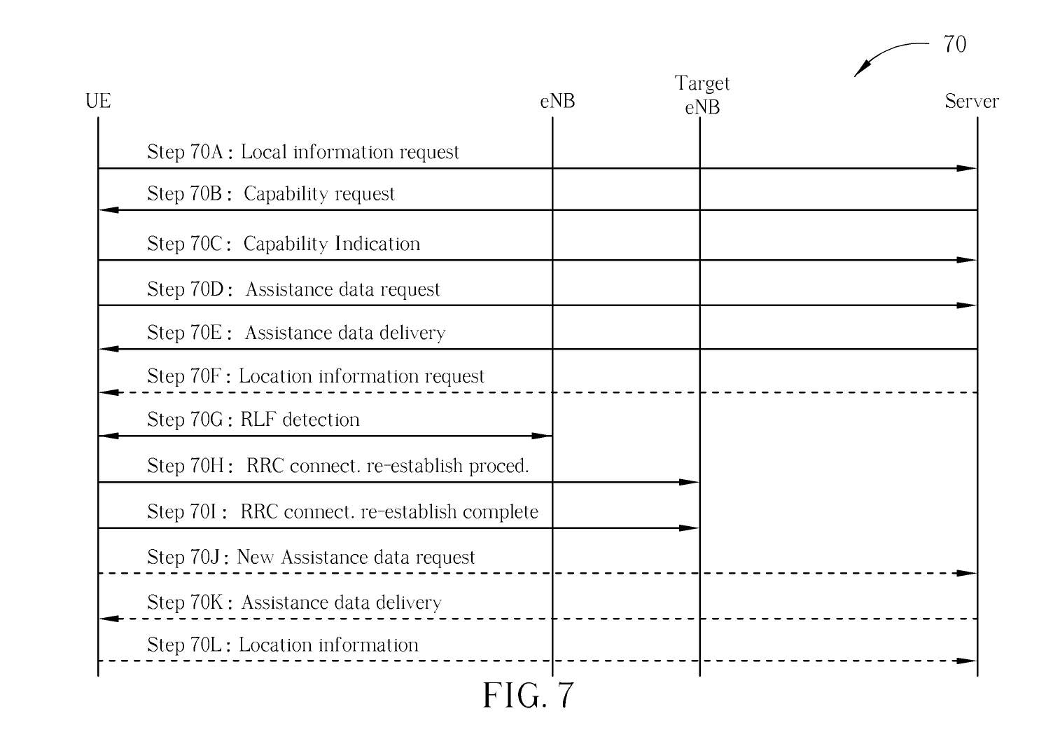

Please refer to FIG. 7, which illustrates a sequence diagram 70 between a UE and a server according to an exemplary of the present disclosure. In the Steps 70A and 70B, the server sends a capability request to the UE, and the UE sends a capability indication back to the server. In the Steps 70C and 70D, the UE sends an assistance data request to the server, and the server delivers the assistance data to the UE. The server sends a location information request to the UE in the Step 70E. In the steps 70F and 70G, the UE detects a radio link failure and thus performs an RRC connection re-establishment procedure to an eNB. The RRC connection re-establishment procedure is involved in the cell change. In the step 70H, the UE notifies a target eNB that the RRC connection re-establishment procedure is completed. After the RRC connection re-establishment procedure, the UE moves from a serving cell (e.g. cell C1) to a new cell (e.g. Cell C2). The assistance data the UE has received is merely associated with the serving cell (e.g. cell C1) and turns obsolete for the positioning. Thus, the RRC connection re-establishment procedure, the UE sends a new assistance data request to the server (Step 701) after the RRC connection re-establishment procedure. In the step 70J, the server sends the UE the updated assistance data. In the step 70k the UE sends location information to the server.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20, in which the processor 200 processes the program code 214 related to the abovementioned processes and the processed results, can updating management information in a wireless communication system.

To sum up, during the positioning, the management information (e.g. the assistance data or location information) may be considered obsolete after the procedure involved in the cell change (e.g. handover procedure or RRC connection re-establishment procedure). According to examples of the present disclosure, the UE sends a new request for the updated assistance data after the procedure (e.g. handover procedure or RRC connection re-establishment procedure) and resends the new location information to the server. This can prevent the obsolete management information from being used for location estimation calculation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of updating management information for a mobile device in a wireless communication system, the method comprising:
performing a procedure involved in a cell change from a first cell to a second cell;
sending a first request to a network for first assistance data associated with the second cell when the procedure is finished; and
receiving the first assistance data from the network.

2. The method of claim 1 further comprising:
sending a second request to the network for second assistance data associated with the first cell before the procedure is performed.

3. The method of claim 2, wherein the first assistance data corresponds to location information of the mobile device corresponding to the second cell and cell information associated with the second cell and other neighboring cells of the mobile device.

4. The method of claim 3, wherein the cell information comprises cell identities of a serving base station controlling the second cell and a plurality of neighbor base stations controlling the neighboring cells.

5. The method of claim 1 further comprising:
receiving a third request that requests for a first location information corresponding to the first cell before the procedure is performed; and
sending a second location information corresponding to the second cell to the network after receiving the first assistance data from the network.

6. The method of claim 5 further comprising:
providing a location estimation result for the network, wherein the location estimation result is calculated based on the second location information corresponding to the second cell.

7. The method of claim 1, wherein the procedure is a handover procedure for handing over the mobile device from the first cell to the second cell.

8. The method of claim 1, wherein the procedure is a radio resource control (RRC) re-establishment procedure for reestablishing RRC connection with the second cell after the mobile device detects a radio link failure.

9. A communication device of updating management information in a wireless communication system, the communication device comprising:
means for performing a procedure involved in a cell change from a first cell to a second cell;
means for sending a first request to a network for first assistance data associated with the second cell when the procedure is finished; and
means for receiving the first assistance data from the network.

10. The communication device of claim 9 further comprising:
means for sending a second request to the network for second assistance data associated with the first cell before the procedure is performed.

11. The communication device of claim 10, wherein the first assistance data corresponds to location information of the mobile device corresponding to the second cell and cell information associated with the second cell and other neighboring cells of the mobile device.

12. The communication device of claim 11, wherein the cell information comprises cell identities of a serving base station controlling the second cell and a plurality of neighbor base stations controlling the neighboring cells.

13. The communication device of claim 9 further comprising:
means for receiving a third request that requests for a first location information corresponding to the first cell before the procedure is performed; and
means for sending a second location information corresponding to the second cell to the network after receiving the first assistance data from the network.

14. The communication device of claim 13 further comprising:
means for providing a location estimation result for the network, wherein the location estimation result is calculated based on the second location information corresponding to the second cell.

15. The communication device of claim 9, wherein the procedure is a handover procedure for handing over the mobile device from the first cell to the second cell.

16. The communication device of claim 9, wherein the procedure is a radio resource control (RRC) re-establishment procedure for reestablishing RRC connection with the second cell after the mobile device detects a radio link failure.
